(19) United States
(12) Patent Application Publication
(10) Pub. No.: US 2024/0403873 A1
(43) Pub. Date: Dec. 5, 2024

(54) CROSS-CHAIN TRANSACTIONS WITH HASH TIME LOCK CONTRACTS IN A DISTRIBUTED LEDGER SYSTEM

(71) Applicant: Goldman Sachs & Co. LLC, New York, NY (US)

(72) Inventors: Chi Kit Yip, Hong Kong (HK); Alun Geoffrey Perkins, London (GB); Manoj Prema Ramesh, Singapore (SG); Andrew Johnson, London (GB)

(21) Appl. No.: 18/205,861

(22) Filed: Jun. 5, 2023

(51) Int. Cl. G06Q 20/38; G06Q 20/40

(52) U.S. Cl. CPC G06Q 20/389; G06Q 20/3825; G06Q 20/3827; G06Q 20/401

(57) ABSTRACT

A settlement bot receives a hashlock value from a source entity delegate bot. The hashlock value is based on a secret value. The settlement bot also receives transaction information. The settlement bot generates a set of settlement instructions based on the transaction information. The set of settlement instructions includes one or more smart contracts governing one or more transactions on a distributed ledger. The settlement bot locks an asset in a first HTLC using the hashlock value. The first HTLC is associated with the set of settlement instructions. The settlement bot settles the set of settlement instructions upon receiving the secret value. Settling the set of settlement instructions includes unlocking the first HTLC and executing the set of settlement instructions, which includes transferring the asset to a destination account.

### TECHNICAL FIELD

The disclosure relates generally to the field of blockchains, and in particular to cross-chain transactions in a distributed ledger system.

### BACKGROUND

Distributed ledgers (e.g., blockchains) were developed as a means for parties to engage in transactions, e.g., financial transactions, without the need for a single, trusted intermediary. In such systems, each transaction is recorded independently by several nodes. In some implementations, no one entity controls all of the nodes so it is exceedingly difficult for a malicious actor to alter the transaction once it has been recorded by the nodes. Even in implementations where a single entity controls all of the nodes, it is still exceedingly difficult to alter the data recorded on sufficient nodes to change the consensus indicated by all of the nodes without leaving an indication that the data has been tampered with.

At a high level, a cryptocurrency functions by defining tokens for which transfers occur on a blockchain. Thus, someone purporting to hold a token can be established by inspecting the transaction history stored on the blockchain. However, exchanging cryptocurrency or other assets for which transactions are recorded on different blockchains for each other is difficult due to the structure of blockchains, which silo assets into their respective ledgers. Unlike physical currency, which can be physically moved from one location to another, digital assets on a blockchain are baked into that blockchain and cannot be simply transferred to another chain. Furthermore, the lack of a central authority to oversee a transaction across blockchains means the threat of fraud, such as where one party to an exchange may refrain from sending their asset on one blockchain to the other party after receiving the other party's asset on a second blockchain, is ever present. These existing technical limitations make it impractical to exchange assets across blockchains, further entrenching the balkanization of blockchain technologies and making it more difficult to technologically integrate disparate blockchain implementations. Creating interoperability for disparate blockchain implementations is a technical challenge that could produce a more powerful and utilizable distributed ledger environment.

### SUMMARY

The above and other problems may be solved using a novel implementation of hash time locked contracts that allows for atomic cross-chain transactions, including chained settlements, that involve accounts associated with custodians. The techniques put forth enable entities to perform complex exchanges of cryptocurrency and other digital assets across ledgers quickly and safely. Thus, the described approach provides distributed ledger technology that enables blockchains to be used in ways that were previously not possible. Furthermore, the described techniques may enable compliance with financial regulations in ways that are not possible with conventional blockchain implementations, enabling the broader adaptation of distributed ledger technology in the financial space.

Aspects of the present disclosure include computer-implemented methods of cross-chain transactions. In one embodiment, a method includes a settlement bot, executing on a source ledger, receiving from a source entity delegate bot representing a source entity and executing on the source ledger, a hashlock value. The hashlock value is based on a secret value generated by the source entity delegate bot. The settlement bot also receives, from the source entity delegate bot, transaction information. The transaction information includes a cross-ledger transaction identifier, an identifier of a source asset associated with the source entity on the source ledger, and an identifier of a destination entity.

The settlement bot generates a set of settlement instructions based on the transaction information. The set of settlement instructions includes one or more smart contracts governing one or more transactions on the source ledger, including a particular transaction to transfer the source asset from the source entity to the destination entity on the source ledger.

The settlement bot locks the source asset in a first HTLC using the hashlock value. The first HTLC is associated with the set of settlement instructions based on the cross-ledger transaction identifier. The settlement bot receives the secret value. For example, depending upon the embodiment, the settlement bot receives the secret value from one or more of the source entity delegate bot, the destination entity delegate bot, and the second settlement bot. Receiving the secret value may include reading the secret value from the source ledger on which it may be published.

The settlement bot settles the set of settlement instructions. Settling the set of settlement instructions includes unlocking the first HTLC using the secret value. Settling the set of settlement instructions also includes executing the set of settlement instructions, which includes transferring the source asset to the destination account on the source ledger that is associated with the destination entity.

Aspects of the present disclosure include a non-transitory computer-readable medium storing instructions that, when executed by a processor, cause the processor to perform the computer-implemented method.

Aspects of the present disclosure include a networked computing system suitable for cross-chain transactions, the networked computing system including: a device configured to perform the computer-implemented method.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 is a block diagram that illustrates a networked computing environment suitable for providing cross-chain transaction functionality, according to one embodiment.

FIG. 2 is a block diagram illustrating two distributed ledgers involved in a cross-chain transaction, according to one embodiment.

FIG. 3 is a block diagram that illustrates an example of a computer suitable for use in the networked computing environment of FIG. 1, according to one embodiment.

FIG. 4 is a flowchart of a method for atomic cross-chain transactions, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Example Systems

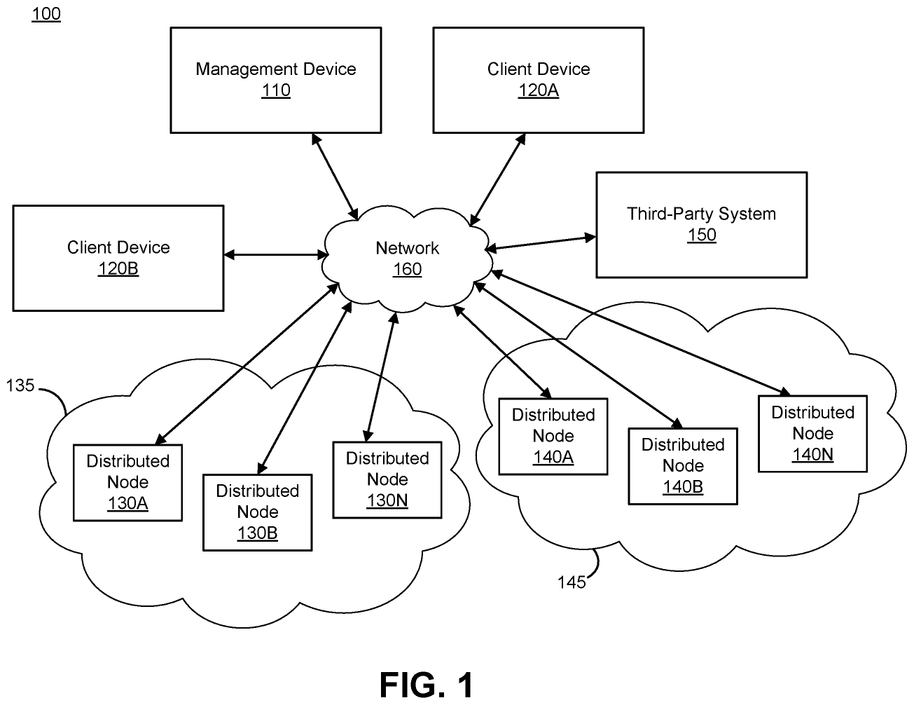

FIG. 1 illustrates one embodiment of a networked computing environment 100 suitable for cross-chain transactions. In the embodiment shown, the networked computing environment 100 includes a management device 110, a client device 120, a first distributed ledger 135 including a first set of distributed nodes 130, a second distributed ledger 145 including a second set of distributed nodes 140, and a third-party system 150, all connected via a network 160. In other embodiments, the networked computing environment 100 includes fewer, different, or additional elements. In addition, the functions may be distributed among the elements in a different manner than described. For example, the networked computing environment 100 may not include a third-party system 150 in some embodiments.

The management device 110 is a computing device (e.g., of a financial institution or an organization administrating a distributed ledger) that provides bots for atomic cross-chain transactions, as further described below. Although only one management device 110 is shown, in practice there may be any number of such devices.

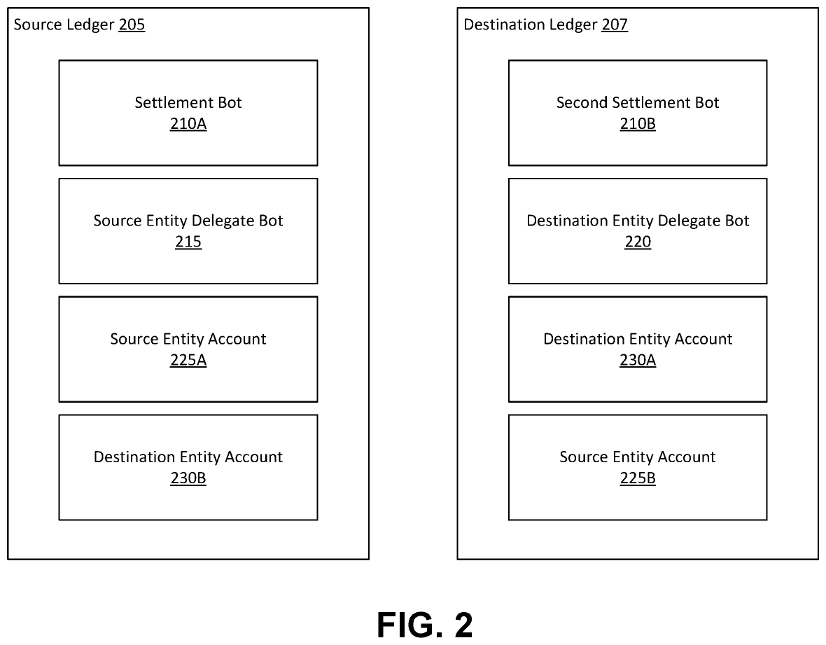

The client device 120 is a computing device with which a user (e.g., a customer of the financial institution) may interact with a distributed ledger, such as distributed ledger 135 or distributed ledger 140. In one embodiment, the management device 110 provides information to the client device 120 to drive a user interface (e.g., in an app or portal displayed via a web browser). Using the user interface, the user may initiate transactions on one or more distributed ledgers and otherwise interact with the distributed ledger, e.g., to review data pertaining to a transaction, to approve of a transaction, to deny a transaction, to adjust a transaction, or so on. The transactions may involve digital assets, such as cryptocurrency, non-fungible tokens, central bank digital currency (CBDC), financial securities, or so on. A user may interact with multiple different distributed ledgers using the client device 120, e.g., bitcoin and Ethereum. Although FIG. 2 includes two client devices 120, the environment may include any number of client devices. Each client device 120 may be associated with a different user, and each user may have one or more accounts on one or more distributed ledgers. Each user may be considered an entity. For example, a first user may be a source entity and a second user may be a destination entity, as described below.

In one embodiment, a distributed ledger includes a blockchain, which is a transactional record that is maintained at each node of a networked computing environment, such as the first set of distributed nodes 130 of distributed ledger 135 or the second set of distributed nodes 140 of distributed ledger 145. The blockchain includes groupings of transactions bundled together into a “block”. When a change to the blockchain is made (e.g., when a new transaction or block is created), the nodes form a consensus as to how the change is integrated into the network of distributed nodes. Upon consensus, the agreed upon change is confirmed to distributed node so that each node maintains a copy that should match the copies stored by other nodes. Any change that does not achieve a consensus may be ignored. Accordingly, unlike a traditional, centralized ledger, a single party cannot unilaterally alter the blockchain. In other embodiments, other types of distributed ledger may be used. The distributed ledgers 135, 145 may be for different crypto-assets, such as bitcoin and Ethereum.

The distributed nodes 130, 140 are computing devices. The distributed nodes may manage and provide a blockchain or other type of distributed ledger. The distributed nodes can also store and execute the rules set by a smart contract. Thus, when one or more triggering conditions of a smart contract is met, one or more operations may be automatically performed by the distributed nodes. In various embodiments, the distributed nodes can operate outside of the management device 110. When an event or data relevant to a smart contract is generated, relevant information may be added to a block of the blockchain. The blockchain and smart contract can codify and automatically enforce rules governing atomic cross-chain transactions.

FIG. 1 shows three distributed nodes 130 (a first distributed node 130A, a second distributed node 130B, and an Nth distributed node 130N), and similarly three distributed nodes 140, but in practice there can (and likely will) be many more such nodes. In various embodiments, each distributed node receives definitions of smart contracts and transactions and maintains an independent record of the smart contracts and transactions.

When a distributed node 130 receives a request to conduct a transaction it confirms or denies whether the relevant data of the transaction is consistent with its records. A transaction is considered successfully verified if a threshold amount of the distributed nodes agree that the transaction is consistent with their records. For example, a Byzantine fault tolerance approach may be used to determine whether sufficient nodes confirm the validity of a transaction to verify the transaction. Similarly, an action defined in a rule of a smart contract may be triggered if a threshold amount of the distributed nodes agree that a triggering condition for the action has been met.

The third-party system 150 is a computing device of a different entity than the management device 110, such as a different financial institution. For example, the user associated with client device 120A may have an account with a financial institution associated with management device 110, and the user associated with client device 120 may have an account with the financial institution associated with third-party system 150. In other embodiments, the third-party system 150 may serve other functions, and the environment may include no third-party system 150 or more than one third-party system 150.

The network 160 provides the communication channels via which the other elements of the networked computing environment 100 communicate. The network 160 can include any combination of local area or wide area networks, using both wired or wireless communication systems. In one embodiment, the network 160 uses standard communications technologies or protocols. For example, the network 160 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 160 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 160 may be represented using any suitable format, such as hypertext markup language (HTML) or extensible markup language (XML). In some embodiments, all or some of the communication links of the network 160 may be encrypted using any suitable technique or techniques.

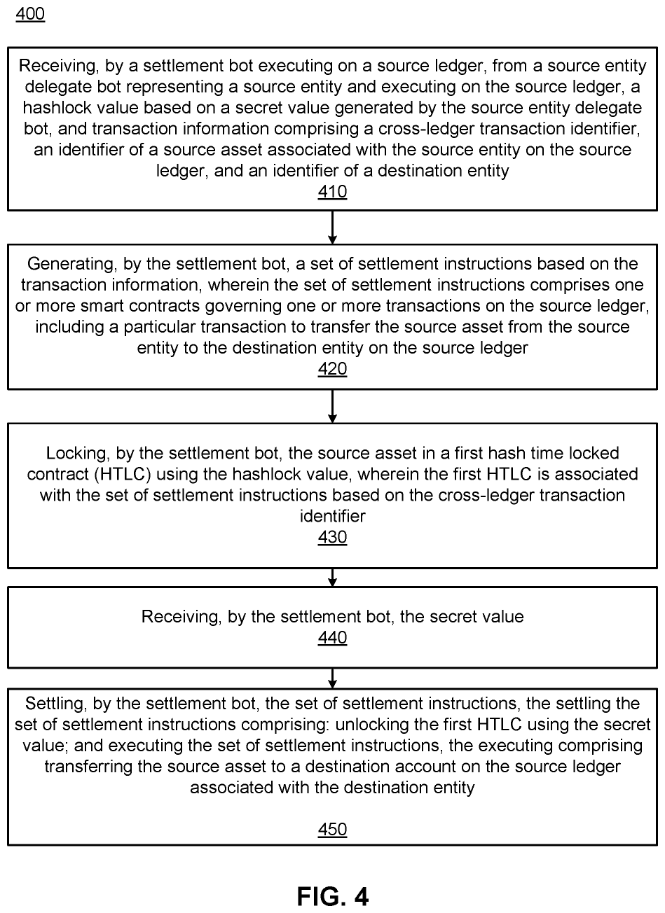

FIG. 2 is a block diagram illustrating two distributed ledgers involved in a cross-chain transaction, according to one embodiment. The two distributed ledgers include a source ledger 205 and a destination ledger 207. The settlement bot 210A and second settlement bot 210B are processes executing on the ledgers to automate portions of the techniques described, as described in further detail below. Similarly, the source entity delegate bot 215 and the destination entity delegate bot 220 act on behalf of users on the ledgers. Each delegate bot may be provided by the management device 110 or by a different financial institution. Each source entity account 225 and each destination entity account 230 is a user account, such as a wallet, on a ledger. For example, a first user, the source entity, has a source entity account 225A on the source ledger 205 and a source entity account 225B on the destination ledger 207. Similarly, a second user, the destination entity, has a destination entity account 230A on the destination ledger 207 and a destination entity account 230B on the source ledger 205. The users can perform transactions, including cross-chain transactions, to move assets among accounts, as described further below with reference to FIG. 4.

### Computing System Architecture

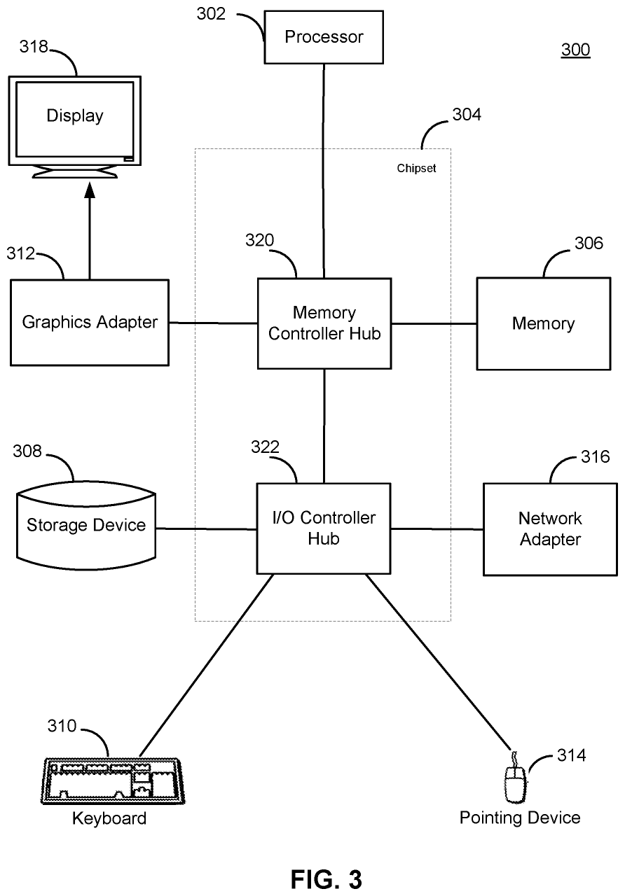

FIG. 3 illustrates an example computer 300 suitable for use as a management device 110, client device 120, distributed node 130 or 140, or third-party system 150, according to one embodiment. The example computer 300 includes at least one processor 302 coupled to a chipset 304. The chipset 304 includes a memory controller hub 320 and an input/output (I/O) controller hub 322. A memory 306 and a graphics adapter 312 are coupled to the memory controller hub 320, and a display 318 is coupled to the graphics adapter 312. A storage device 308, keyboard 310, pointing device 314, and network adapter 316 are coupled to the I/O controller hub 322. Other embodiments of the computer 300 have different architectures.

In the embodiment shown in FIG. 3, the storage device 308 is a non-transitory computer-readable storage medium such as a hard drive, compact disk read-only memory (CD-ROM), DVD, or a solid-state memory device. The memory 306 holds instructions, e.g., to perform the methods described herein, and data used by the processor 302. The pointing device 314 is a mouse, track ball, touchscreen, or other type of pointing device, and is used in combination with the keyboard 310 (which may be an on-screen keyboard) to input data into the computer system 300. The graphics adapter 312 displays images and other information on the display 318. The network adapter 316 couples the computer system 300 to one or more computer networks (e.g., network 170). The types of computers used by the entities of FIG. 1 can vary depending upon the embodiment and the processing power required by the entity. Furthermore, the computers can lack some of the components described above, such as keyboards 310, graphics adapters 312, and displays 318.

### Example Methods

FIG. 4 illustrates one embodiment of a method 400 for atomic cross-chain transactions. The steps of FIG. 4 are illustrated from the perspective of a settlement bot 210A performing the method 400. However, some or all of the steps may be performed by other entities or components. In addition, some embodiments may perform the steps in parallel, perform the steps in different orders, or perform different steps.

In the embodiment shown, the method 400 begins with the settlement bot 210A, executing on a source ledger 205, receiving 410 a hashlock value from a source entity delegate bot 215 representing a source entity 225 and executing on the source ledger 205. The hashlock value is based on a secret value generated by the source entity delegate bot 215. The settlement bot 210A also receives 410 transaction information from the source entity delegate bot 215. The transaction information includes a cross-ledger transaction identifier, an identifier of a source asset associated with the source entity 225 on the source ledger 205, and an identifier of a destination entity 230.

The settlement bot 210A generates 420 a set of settlement instructions based on the transaction information. The set of settlement instructions includes one or more smart contracts governing one or more transactions on the source ledger 205, including a particular transaction to transfer the source asset from the source entity 225 to the destination entity 230 on the source ledger 205. For example, the particular transaction involves transferring the source asset from the source entity account 225A on the source ledger 205 to the destination entity account 230B on the source ledger 205.

The settlement bot 210A locks 430 the source asset in a first HTLC using the hashlock value. The first HTLC is associated with the set of settlement instructions based on the cross-ledger transaction identifier. The settlement bot 210A receives 440 the secret value. For example, depending upon the embodiment, the settlement bot 210A receives 440 the secret value from one or more of the source entity delegate bot 215, the destination entity delegate bot 220, and the second settlement bot 210B. Receiving the secret value may include reading the secret value from the source ledger 205 on which it may be published.

The settlement bot 210A settles the set of settlement instructions. Settling the set of settlement instructions includes unlocking the first HTLC using the secret value. Settling the set of settlement instructions also includes executing the set of settlement instructions, which includes transferring the source asset to the destination account 230B on the source ledger 205 that is associated with the destination entity 230.

In one or more embodiments, the source entity delegate bot 215 executing on the source ledger is associated with the settlement bot 210A, and the method 400 further includes determining, by the source entity delegate bot 215, that a second HTLC on a destination ledger 207, identified by the cross-ledger transaction identifier, is locked using the hashlock value. Furthermore, responsive to determining the second HTLC is locked, the source entity delegate bot 215 publishes the secret value on the destination ledger 207.

In one or more embodiments, the settlement bot 210A executing on the source ledger is associated with a second settlement bot 210B executing on the destination ledger 207, and the method 400 further includes a destination entity delegate bot 220 executing on the destination ledger 207 determining that the first HTLC is locked. Responsive to determining that the first HTLC is locked, the destination entity delegate bot 220 extracts, from the first HTLC, the hashlock value, and publishes the hashlock value on the destination ledger 207. Responsive to the publishing of the hashlock value on the destination ledger 207, the second settlement bot 210B generates a second set of settlement instructions based on the transaction information. The second set of settlement instructions includes one or more smart contracts governing one or more transactions on the destination ledger 207, including a particular transaction to transfer a destination asset from the destination entity to the source entity on the destination ledger 207. The second settlement bot 210B locks the destination asset in the second HTLC on the destination ledger 207, with the second HTLC being associated with the second set of settlement instructions based on the cross-ledger transaction identifier. Responsive to the source entity delegate bot 215 publishing the secret value on the destination ledger 207, the settlement agent unlocks the second HTLC, executes the second set of settlement instructions, and publishes the secret value on the source ledger 205.

In one or more embodiments, the second HTLC includes a second set of settlement instructions, and publishing the secret value is further responsive to verifying the second set of settlement instructions are congruent with the transaction information.

In one or more embodiments, the settlement bot 210A locks the first HTLC responsive to receiving approval of the set of settlement instructions from both of a source entity associated with the source entity delegate bot 215 and a custodian entity associated with the source entity. The approval from the source entity may include a first cryptographic signature and the approval from the custodian entity may include a second cryptographic signature.

In one or more embodiments, the transaction information includes an identifier of the source entity, and the identifier of the source entity is not a blockchain wallet identifier. For example, the identifier of the source entity may be a global identifier, such as a legal entity identifier (LEI).

In one or more embodiments, the method further includes the source entity delegate bot 215 storing the secret value in association with the cross-chain transaction identifier at a remote database. The source entity delegate bot 215, responsive to determining the second HTLC is locked, extracts the cross-chain transaction identifier from the second HTLC and retrieves the secret value from the remote database using the extracted cross-chain transaction identifier.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing cross-chain transactions using HTLCs. Thus, while particular embodiments and applications have been illustrated and described, it is to be understood that the described subject matter is not limited to the precise construction and components disclosed. The scope of protection should be limited only by any claims that may ultimately issue.

What is claimed is:

1. A computer-implemented method, comprising:
receiving, by a settlement bot executing on a source ledger, from a source entity delegate bot representing a source entity and executing on the source ledger, a hashlock value based on a secret value generated by the source entity delegate bot, and transaction information comprising a cross-ledger transaction identifier, an identifier of a source asset associated with the source entity on the source ledger, and an identifier of a destination entity;
generating, by the settlement bot, a set of settlement instructions based on the transaction information, wherein the set of settlement instructions comprises one or more smart contracts governing one or more transactions on the source ledger, including a particular transaction to transfer the source asset from the source entity to the destination entity on the source ledger;
locking, by the settlement bot, the source asset in a first hash time locked contract (HTLC) using the hashlock value, wherein the first HTLC is associated with the set of settlement instructions based on the cross-ledger transaction identifier;
receiving, by the settlement bot, the secret value; and
settling, by the settlement bot, the set of settlement instructions, the settling the set of settlement instructions comprising:
unlocking the first HTLC using the secret value; and
executing the set of settlement instructions, the executing comprising transferring the source asset to a destination account on the source ledger associated with the destination entity.

2. The method of claim 1, wherein the source entity delegate bot executing on the source ledger is associated with the settlement bot, the method further comprising:
determining, by the source entity delegate bot, that a second HTLC on a destination ledger, identified by the cross-ledger transaction identifier, is locked using the hashlock value; and
responsive to determining the second HTLC is locked, publishing, by the source entity delegate bot, the secret value on the destination ledger.

3. The method of claim 2, wherein the settlement bot executing on the source ledger is associated with a second settlement bot executing on the destination ledger, the method further comprising:
determining, by a destination entity delegate bot executing on the destination ledger, that the first HTLC is locked;
responsive to determining that the first HTLC is locked:
extracting, by the destination entity delegate bot, from the first HTLC, the hashlock value; and
publishing, by the destination entity delegate bot, the hashlock value on the destination ledger;
responsive to the publishing of the hashlock value on the destination ledger, generating, by the second settlement bot, a second set of settlement instructions based on the transaction information, wherein the second set of settlement instructions comprises one or more smart contracts governing one or more transactions on the destination ledger, including a particular transaction to transfer a destination asset from the destination entity to the source entity on the destination ledger;
locking, by the second settlement bot, the destination asset in the second HTLC on the destination ledger, wherein the second HTLC is associated with the second set of settlement instructions based on the cross-ledger transaction identifier; and
responsive to publishing, by the source entity delegate bot, the secret value on the destination ledger:
unlocking, by the second settlement agent, the second HTLC;
executing, by the second settlement agent, the second set of settlement instructions; and
publishing the secret value on the source ledger.

4. The method of claim 2, wherein the second HTLC comprises a second set of settlement instructions, and publishing the secret value is further responsive to:
verifying the second set of settlement instructions are congruent with the transaction information.

5. The method of claim 1, wherein the settlement bot locks the first HTLC responsive to:
receiving, by the settlement bot, from a source entity associated with the source entity delegate bot, approval of the set of settlement instructions, comprising a first cryptographic signature; and
receiving, by the settlement bot, from a custodian entity associated with the source entity, approval of the set of settlement instructions, comprising a second cryptographic signature.

6. The method of claim 1, wherein the transaction information comprises an identifier of the source entity, and the identifier of the source entity is not a blockchain wallet identifier.

7. The method of claim 1, the method further comprising:
storing, by the source entity delegate bot, the secret value in association with the cross-chain transaction identifier at a remote database; and
responsive to determining the second HTLC is locked:
extracting the cross-chain transaction identifier from the second HTLC; and
retrieving the secret value from the remote database using the extracted cross-chain transaction identifier.

8. A non-transitory computer-readable storage medium storing computer program instructions executable by a processor, the instructions comprising instructions to:
receive, by a settlement bot executing on a source ledger, from a source entity delegate bot representing a source entity and executing on the source ledger, a hashlock value based on a secret value generated by the source entity delegate bot, and transaction information comprising a cross-ledger transaction identifier, an identifier of a source asset associated with the source entity on the source ledger, and an identifier of a destination entity;
generate, by the settlement bot, a set of settlement instructions based on the transaction information, wherein the set of settlement instructions comprises one or more smart contracts governing one or more transactions on the source ledger, including a particular transaction to transfer the source asset from the source entity to the destination entity on the source ledger;
lock, by the settlement bot, the source asset in a first hash time locked contract (HTLC) using the hashlock value, wherein the first HTLC is associated with the set of settlement instructions based on the cross-ledger transaction identifier;
receive, by the settlement bot, the secret value; and
settle, by the settlement bot, the set of settlement instructions, instructions to settle the set of settlement instructions comprising instructions to:
unlock the first HTLC using the secret value; and
execute the set of settlement instructions, the executing comprising transferring the source asset to a destination account on the source ledger associated with the destination entity.

9. The non-transitory computer-readable storage medium of claim 8, wherein the source entity delegate bot executing on the source ledger is associated with the settlement bot, instructions further comprising instructions to:
determine, by the source entity delegate bot, that a second HTLC on a destination ledger, identified by the cross-ledger transaction identifier, is locked using the hashlock value; and
responsive to determining the second HTLC is locked, publish, by the source entity delegate bot, the secret value on the destination ledger.

10. The non-transitory computer-readable storage medium of claim 9, wherein the settlement bot executing on the source ledger is associated with a second settlement bot executing on the destination ledger, the instructions further comprising instructions to:
determine, by a destination entity delegate bot executing on the destination ledger, that the first HTLC is locked;
responsive to determining that the first HTLC is locked:
extract, by the destination entity delegate bot, from the first HTLC, the hashlock value; and
publish, by the destination entity delegate bot, the hashlock value on the destination ledger;
responsive to the publishing of the hashlock value on the destination ledger, generate, by the second settlement bot, a second set of settlement instructions based on the transaction information, wherein the second set of settlement instructions comprises one or more smart contracts governing one or more transactions on the destination ledger, including a particular transaction to transfer a destination asset from the destination entity to the source entity on the destination ledger;
lock, by the second settlement bot, the destination asset in the second HTLC on the destination ledger, wherein the second HTLC is associated with the second set of settlement instructions based on the cross-ledger transaction identifier; and
responsive to publishing, by the source entity delegate bot, the secret value on the destination ledger:
unlock, by the second settlement agent, the second HTLC;
execute, by the second settlement agent, the second set of settlement instructions; and
publish the secret value on the source ledger.

11. The non-transitory computer-readable storage medium of claim 9, wherein the second HTLC comprises a second set of settlement instructions, and publishing the secret value is further responsive to:
verifying the second set of settlement instructions are congruent with the transaction information.

12. The non-transitory computer-readable storage medium of claim 8, wherein the settlement bot locks the first HTLC responsive to:
receiving, by the settlement bot, from a source entity associated with the source entity delegate bot, approval of the set of settlement instructions, comprising a first cryptographic signature; and
receiving, by the settlement bot, from a custodian entity associated with the source entity, approval of the set of settlement instructions, comprising a second cryptographic signature.

13. The non-transitory computer-readable storage medium of claim 8, wherein the transaction information comprises an identifier of the source entity, and the identifier of the source entity is not a blockchain wallet identifier.

14. The non-transitory computer-readable storage medium of claim 8, the instructions further comprising instructions to:
store, by the source entity delegate bot, the secret value in association with the cross-chain transaction identifier at a remote database; and
responsive to determining the second HTLC is locked:
extract the cross-chain transaction identifier from the second HTLC; and
retrieve the secret value from the remote database using the extracted cross-chain transaction identifier.

15. A system, comprising:
a processor; and
a non-transitory computer-readable storage medium storing computer program instructions executable by the processor, the computer program instructions comprising instructions to:
receive, by a settlement bot executing on a source ledger, from a source entity delegate bot representing a source entity and executing on the source ledger, a hashlock value based on a secret value generated by the source entity delegate bot, and transaction information comprising a cross-ledger transaction identifier, an identifier of a source asset associated with the source entity on the source ledger, and an identifier of a destination entity;
generate, by the settlement bot, a set of settlement instructions based on the transaction information, wherein the set of settlement instructions comprises one or more smart contracts governing one or more transactions on the source ledger, including a particular transaction to transfer the source asset from the source entity to the destination entity on the source ledger;
lock, by the settlement bot, the source asset in a first hash time locked contract (HTLC) using the hashlock value, wherein the first HTLC is associated with the set of settlement instructions based on the cross-ledger transaction identifier;
receive, by the settlement bot, the secret value; and
settle, by the settlement bot, the set of settlement instructions, instructions to settle the set of settlement instructions comprising instructions to:
unlock the first HTLC using the secret value; and
execute the set of settlement instructions, the executing comprising transferring the source asset to a destination account on the source ledger associated with the destination entity.

16. The system of claim 15, wherein the source entity delegate bot executing on the source ledger is associated with the settlement bot, instructions further comprising instructions to:
determine, by the source entity delegate bot, that a second HTLC on a destination ledger, identified by the cross-ledger transaction identifier, is locked using the hashlock value; and
responsive to determining the second HTLC is locked, publish, by the source entity delegate bot, the secret value on the destination ledger.

17. The system of claim 16, wherein the settlement bot executing on the source ledger is associated with a second settlement bot executing on the destination ledger, the instructions further comprising instructions to:
determine, by a destination entity delegate bot executing on the destination ledger, that the first HTLC is locked;
responsive to determining that the first HTLC is locked:
extract, by the destination entity delegate bot, from the first HTLC, the hashlock value; and
publish, by the destination entity delegate bot, the hashlock value on the destination ledger;
responsive to the publishing of the hashlock value on the destination ledger, generate, by the second settlement bot, a second set of settlement instructions based on the transaction information, wherein the second set of settlement instructions comprises one or more smart contracts governing one or more transactions on the destination ledger, including a particular transaction to transfer a destination asset from the destination entity to the source entity on the destination ledger;
lock, by the second settlement bot, the destination asset in the second HTLC on the destination ledger, wherein the second HTLC is associated with the second set of settlement instructions based on the cross-ledger transaction identifier; and
responsive to publishing, by the source entity delegate bot, the secret value on the destination ledger:
unlock, by the second settlement agent, the second HTLC;
execute, by the second settlement agent, the second set of settlement instructions; and
publish the secret value on the source ledger.

18. The system of claim 16, wherein the second HTLC comprises a second set of settlement instructions, and publishing the secret value is further responsive to:
verifying the second set of settlement instructions are congruent with the transaction information.

19. The system of claim 15, wherein the settlement bot locks the first HTLC responsive to:
receiving, by the settlement bot, from a source entity associated with the source entity delegate bot, approval of the set of settlement instructions, comprising a first cryptographic signature; and
receiving, by the settlement bot, from a custodian entity associated with the source entity, approval of the set of settlement instructions, comprising a second cryptographic signature.

20. The system of claim 15, the instructions further comprising instructions to:
store, by the source entity delegate bot, the secret value in association with the cross-chain transaction identifier at a remote database; and
responsive to determining the second HTLC is locked:
extract the cross-chain transaction identifier from the second HTLC; and
retrieve the secret value from the remote database using the extracted cross-chain transaction identifier.
